(19) United States
(12) Patent Application Publication
(10) Pub. No.: US 2025/0236773 A1
(43) Pub. Date: Jul. 24, 2025

(54) HOT-MELT ADHESIVE COMPOSITION

(71) Applicant: Bostik SA, COLOMBES (FR)

(72) Inventor: Thomas PRENVEILLE, SERQUIGNY (FR)

(21) Appl. No.: 18/698,068

(22) PCT Filed: Oct. 13, 2022
(86) PCT No.: PCT/FR2022/051930

§ 371 Date: Apr. 3, 2024

(30) Foreign Application Priority Data
Oct. 14, 2021 (FR) FR2110895

(51) Int. Cl. C09J 177/08; C08K 3/04; C08K 3/22; C08K 3/34; C09J 9/00

(52) U.S. Cl. CPC C09J 177/08; C08K 3/04; C08K 3/34; C09J 9/00; C08K 2003/2296; C08K 2201/005; C08K 2201/006

(57) ABSTRACT

The invention relates to a hot-melt adhesive composition comprising:
i) at least one specific semicrystalline aliphatic copolyamide,
ii) at least one filler, the content of carbon atoms of which is between 60% and 100% relative to the number of atoms constituting the filler,
the carbon-based filler having a D90 median average particle size ranging from 1 to 400 micrometers,
iii) at least one electrically insulating filler chosen from oxides of metals and nitrides,
the sum of the contents of carbon-based filler and of electrically insulating filler is between 30% and 75% by weight relative to the total weight of the composition, said fillers having a D90 median average particle size ranging from 1 to 400 micrometers.

The invention also relates to a process for the preparation thereof and to the use thereof.

The present invention relates to a hot-melt adhesive composition for the encapsulation of electronic devices, to a process for the preparation of such a composition and also to the use thereof.

It is known to use polyamides as hot-melt adhesives for encapsulating electronic or mechanical devices used, for example, in the automotive fields or in the medical field. Specifically, plastic materials are generally used to protect batteries, whether within an automobile or else whether, on a smaller scale, a cell phone shell. More particularly, the substrates to be encapsulated can be metals, such as copper, or polymers, such as, for example, materials making up printed circuits. This encapsulation requires being carried out at low pressure, in order not to damage the part to be molded.

Furthermore, these materials must be electrically insulating, in order to avoid possible short circuits. They must also be heat conductors in order to make it possible for, for example, a battery, if this is the element to be encapsulated, to discharge the heat which it generates during its use.

At the implementation level, the encapsulation of the parts requires being carried out at low pressure, in order not to damage the part to be molded. Encapsulation is a delicate process. The material which makes it possible to encapsulate the part is melted. It is subsequently gently deposited hot on the element to be encapsulated. The pressure at the nozzle outlet of the molten material is described as low pressure. The term “wetting” is used to define this encapsulation. Indeed, if the pressure at the nozzle outlet is too high, the force applied to the molten material can damage the part to be encapsulated.

Several low-pressure injection processes are known for encapsulating parts. The process called “epoxy potting” has the disadvantage of being relatively lengthy, resulting in low productivity due to the relatively slow reaction time. The chemical vapor deposition process is itself used in the field of encapsulation. However, this process is known to be dangerous.

Thus, new materials are sought which have to correspond both to specific physicochemical properties and have to make possible an easier, more rapid and secure low-pressure encapsulation process.

There is therefore a real need to provide polymers combining all of the above-mentioned properties, namely thermal conductivity, low viscosity, good mechanical properties and good adhesion properties.

The compositions according to the invention are non-reactive and therefore enable high productivity combined with improved thermal conductivity, adhesion properties and low viscosity, enabling the low-pressure encapsulation of fragile objects. Lastly, the esthetic aspect of the part, good mechanical properties and also a melting point below 220° C. are also important.

### SUMMARY OF THE INVENTION

The invention relates to a hot-melt adhesive composition comprising:
i) at least one semicrystalline aliphatic copolyamide comprising at least two units corresponding to the following formula (1):

X/Y (1)
the unit X is a semicrystalline unit obtained by the polycondensation of a unit chosen from a C6 to C18 α,ω-aminocarboxylic acid, a C6 to C18 lactam and a (Ca diamine). (Cb diacid) unit, with a representing the number of carbon atoms of the diamine and b representing the carbon number of the diacid, a being between 2 and 18 and b being between 4 and 18, the Ca diamine and the Cb diacid being saturated or unsaturated, linear or branched aliphatic or cycloaliphatic,
the unit Y is a unit obtained by the polycondensation of a (Cd diamine). (Ce diacid) unit, with d representing the number of carbon atoms of the diamine and e representing the carbon number of the diacid, d and e being between 2 and 48, the Cd diamine and the Ce diacid being saturated or unsaturated, linear or branched aliphatic or cycloaliphatic, it being possible for the Cd diamine to be a polyetheramine,
the unit Y having a Tg of less than 30° C., advantageously of less than 20° C., very advantageously of less than 0° C.,
the copolyamide having a melt viscosity, measured according to the standard ASTM D3236-88 (2009), of between 0.5 and 300 Pa·s at 200° C.,
the copolyamide constituting the matrix of the composition,
ii) at least one carbon-based filler, the content of carbon atoms of which is between 60% and 100% relative to the number of atoms constituting the filler,
iii) at least one electrically insulating filler chosen from oxides of metals and nitrides,
the sum of the contents of carbon-based filler and of electrically insulating filler is between 30% and 75% by weight relative to the total weight of the composition, and
said fillers having a D90 median average particle size ranging from 1 to 400 micrometers.

The invention also relates to a process for the preparation of the composition according to the invention.

The invention lastly relates to the use of the composition for encapsulating electronic devices.

### DETAILED DESCRIPTION

The invention is now described in more detail and in a nonlimiting manner in the description which follows.

Within the meaning of the present invention, the term “hot-melt” is understood to mean the ability of the composition to melt under the effect of heat.

Throughout the description, unless otherwise indicated, all the percentages indicated are molar percentages.

Within the meaning of the present invention, the expression “between . . . and . . . ” is understood to mean that the limits are included in the range described.

### The Copolyamide

The copolyamide present in the composition according to the invention is semicrystalline and aliphatic.

The expression “semicrystalline copolyamide” covers copolyamides which exhibit both a glass transition temperature Tg and a melting temperature Tm. The Tg and the Tm can be determined respectively according to the standards ISO 11357-2:2013 and 11357-3:2013.

The nomenclature used to define polyamides is described in the standard ISO 1874-1:1992, “Plastics-Polyamide (PA) moulding and extrusion materials-Part 1: Designation”, in particular on page 3 (tables 1 and 2), and is well known to a person skilled in the art. In the PAL notation, PA denotes polyamide and L denotes the number of carbon atoms of the amino acid or else of the lactam. Thus, the polyamide is obtained by the polycondensation of the amino acid or of the lactam comprising L carbon atoms. In the PAMN notation, M denotes the number of carbon atoms of the diamine and N denotes the number of carbon atoms of the diacid.

It comprises at least two units corresponding to the following formula (1):

X/Y (1)

in which:
the unit X is a semicrystalline unit obtained by the polycondensation of a unit chosen from a C6 to C18 α,ω-aminocarboxylic acid, a C6 to C18 lactam and a (Ca diamine). (Cb diacid) unit, with a representing the number of carbon atoms of the diamine and b representing the carbon number of the diacid, a being between 2 and 18 and b being between 4 and 18, the Ca diamine and the Cb diacid being saturated or unsaturated, linear or branched aliphatic or cycloaliphatic,
the unit Y is a unit obtained by the polycondensation of a (Cd diamine). (Ce diacid) unit, with d representing the number of carbon atoms of the diamine and e representing the carbon number of the diacid, d and e being between 2 and 48, the Cd diamine and the Ce diacid being saturated or unsaturated, linear or branched aliphatic or cycloaliphatic, it being possible for the Cd diamine to be a polyetheramine,
the unit Y having a Tg of less than 30° C., advantageously of less than 20° C., very advantageously of less than 0° C.,
the copolyamide having a melt viscosity, measured according to the standard ASTM D3236-88 (2009), of between 0.5 and 300 Pa·s at 200° C., the copolyamide constituting the matrix of the composition.

Advantageously, the polyamide of formula (1) has a ratio: number of carbon atoms to number of nitrogen atoms, denoted C/N, of greater than or equal to 8.

Within the meaning of the present invention, the term “semicrystalline unit” is understood to mean a polyamide which has a melting temperature (Tm) in DSC according to the standard ISO 11357-3:2013, and an enthalpy of crystallization during the stage of cooling at a rate of 5 K/min in DSC, measured according to the standard ISO 11357-3 of 2013, of greater than 15 J/g, preferably of greater than 30 J/g.

The unit X can result from the polycondensation of one or more C6 to C12 α,ω-aminocarboxylic acids. Preferably, the α,ω-aminocarboxylic acid is chosen from 7-aminoheptanoic acid, 11-aminoundecanoic acid and 12-aminododecanoic acid.

The unit X can result from the polycondensation of one or more C6 to C12 lactams. Preferably, the lactam is chosen from caprolactam, enantholactam and lauryllactam.

The unit X can result from the polycondensation of a (Ca diamine). (Cb diacid) unit, with a representing the number of carbon atoms of the diamine and b representing the carbon number of the diacid, a being between 2 and 18 and b being between 4 and 18. More particularly, b is between 5 and 18.

The Ca diamine can be chosen from linear or branched aliphatic diamines or cycloaliphatic diamines.

When the Ca diamine is aliphatic and linear, of formula H2N-(CH2)a-NH2, it is preferentially chosen from ethylenediamine (a=2), butanediamine (a=4), pentanediamine (a=5), hexanediamine (a=6), heptanediamine (a=7), octanediamine (a=8), nonanediamine (a=9), decanediamine (a=10), undecanediamine (a=11), dodecanediamine (a=12), tridecanediamine (a=13), tetradecanediamine (a=14), hexadecanediamine (a=16), octadecanediamine (a=18) or octadecanediamine (a=18).

When the Ca diamine is aliphatic and branched, it can comprise one or more methyl or ethyl substituents on the main chain. For example, it can advantageously be chosen from 2,2,4-trimethyl-1,6-hexanediamine, 2,4,4-trimethyl-1,6-hexanediamine, 2-methyl-1,5-pentanediamine or 2-methyl-1,8-octanediamine.

When the Ca diamine is cycloaliphatic, it can be chosen from piperazine (a=4), denoted pip below, and aminoethylpiperazine (a=6).

Preferably, the Ca diamine is chosen from ethylenediamine, hexamethylenediamine, decanediamine and piperazine.

The Cb diacid can be chosen from linear or branched aliphatic diacids or cycloaliphatic diacids.

Throughout the description, the expressions “diacid”, “carboxylic diacid” and “dicarboxylic acid” denote the same product.

When the Cb diacid is aliphatic, it can be chosen from adipic acid (b=6), heptanedioic acid (b=7), octanedioic acid (b=8), azelaic acid (b=9), sebacic acid (b=10), undecanedioic acid (b=11), dodecanedioic acid (b=12), brassylic acid (b=13), tetradecanedioic acid (b=14), hexadecanedioic acid (b=16), octadecanedioic acid (b=18) or octadecenedioic acid (b=18).

When the diacid is cycloaliphatic, it can comprise the following carbon backbones: norbornyl, cyclohexyl, dicyclohexyl or dicyclohexylpropane.

Preferably, the unit X is chosen from caprolactam, enantholactam and lauryllactam, 7-aminoheptanoic acid, 11-aminoundecanoic acid and 12-aminododecanoic acid, PA 26, PA 29, PA 210, PA 212, PA 214, PA 218, PA 56, PA 59, PA 510, PA 66, PA 69, PA 610, PA 512, PA 612, PA 514, PA 614, PA 618, PA pip10, PA pip12, PA 1010, PA 1012, PA 1014, PA 1018, PA 1210, PA 1212, PA 1214 and PA 1218. More particularly, the unit X is chosen from caprolactam, lauryllactam, 11-aminoundecanoic acid, PA 26, PA 29, PA 210, PA 212, PA 214, PA 218, PA 59, PA 510, PA 69, PA 610, PA 512 and PA 612.

Preferably, the unit X is chosen from an amino acid and a lactam or PA 26, PA 29, PA 210, PA 212, PA 214, PA 218, PA 59, PA 510, PA 66, PA 69, PA 610, PA 512 or PA 612; more particularly, the unit X is chosen from amino acids and lactams having a number of carbon atoms of greater than 6. More particularly, the unit X is a PA 6, a PA 11, a PA 12, a PA 210, a PA 212, a PA 69, a PA 610, or a PA 612.

The unit Y is obtained by the polycondensation of a (Cd diamine). (Ce diacid) unit, with d representing the number of carbon atoms of the diamine and e representing the carbon number of the diacid, d and e being between 2 and 48, the Cd diamine and the Ce diacid being saturated or unsaturated and linear or branched aliphatic, the Cd diamine being chosen from aliphatic diamines, cycloaliphatic diamines and polyetheramines.

The Cd diamine can be chosen from linear or branched aliphatic diamines or cycloaliphatic diamines, as defined above for the Ca diamines.

The Cd diamine can also be chosen from eicosanediamine (a=20) and docosanediamine (a=22).

The Cd diamine can also originate from the amination of polymerized fatty acids, as defined below. The Cd diamine can be a C36 or C44 diamine.

The Cd diamine can also be chosen from bis(3,5-dialkyl-4-aminocyclohexyl) methane, bis(3,5-dialkyl-4-aminocyclohexyl) ethane, bis(3,5-dialkyl-4-aminocyclohexyl) propane, bis(3,5-dialkyl-4-aminocyclohexyl) butane, bis(3-methyl-4-aminocyclohexyl) methane (BMACM or MACM), bis(p-aminocyclohexyl) methane (PACM) and isopropylidenedi(cyclohexylamine) (PACP), isophoronediamine (f=10), piperazine (f=4), denoted pip below, or aminoethylpiperazine. It can also comprise the following carbon backbones: norbornylmethane, cyclohexylmethane, dicyclohexylpropane, di(methylcyclohexyl) or di(methylcyclohexyl) propane. A nonexhaustive list of these cycloaliphatic diamines is given in the publication “Cycloaliphatic Amines” (Encyclopedia of Chemical Technology, Kirk-Othmer, 4th Edition (1992), pp. 386-405).

The Cd diamine can also be a polyetheramine, that is to say a polyoxyalkylenediamine. Preferably, it is a polyoxyalkylene chain bearing an amine group at the chain end. The polyoxyalkylene chain preferably comprises oxyethylene (POE), oxypropylene (POP) or oxytetramethylene (POTM) groups, alone or as a mixture. When the groups are as a mixture, POE and POP or also POTM and POP mixtures are preferred.

These compounds can be obtained by cyanoacetylation of α,ω-dihydroxylated aliphatic polyoxyalkylenes, called polyetherdiols. The polyetheramine is preferably chosen from commercially available products, in particular sold by Huntsman under the Jeffamine® and Elastamine® brands (for example Jeffamine@ D400, D2000, ED 2003 or XTJ 542, Elastamine® RT 1000, RP 405 or RP 2009) or under the Baxxodur® brand by BASF (for example Baxxodur®) EC 302, EC 301, EC 303 or EC 311).

Preferably, the number-average molecular mass of the polyetheramine is between 60 and 2000 g.mol-1, more particularly between 80 and 1500 g.mol-1 and more preferably still between 100 and 500 g.mol-1.

The Cd diamine can also originate from the amination of polymerized fatty acids, as defined below. These diamines are commercially available under the brand name Versamine® sold by Cognis Corporation (BASF) and under the trade name Priamine® from Croda.

The Ce diacid can be chosen from linear or branched aliphatic diacids or cycloaliphatic diacids, as defined above for the Cb diacids.

The Ce diacid can also be chosen from eicosanedioic acid (b=20), docosanedioic acid (b=22) and fatty acid dimers.

The Ce diacid can originate from polymerized fatty acids. These polymerized fatty acids denote compounds produced from coupling reactions of unsaturated fatty acids, which result in mixtures of products bearing two acid functions (denoted acid dimers) or three acid functions (denoted acid trimers). This coupling can be a combination or condensation reaction of two moles of an unsaturated monocarboxylic acid, it being possible for the monoacids to be identical or different. This dimerization reaction can be carried out according to catalytic or noncatalytic polymerization methods according to known methods. For example, the C36 dimer diacid can be obtained by dimerization of an unsaturated C18 monoacid, such as oleic acid, linoleic acid, linolenic acid and a mixture thereof. These mixtures are present, for example, in tall oil. Generally, these mixtures comprise predominantly the dimer, and in lesser amounts the monomer, the trimer and oligomers. After separation, the fatty acid dimers are obtained predominantly from 75% to more than 98%, as a mixture in particular with the corresponding monomer, “1 and 1/2 mer” and trimer.

Dimer diacids can be obtained from C14 myristoleic acid, C16 palmitoleic acid, C16 sapienic acid, C18 oleic acid, C18 elaidic acid, C18 trans-vaccenic acid, C18 linoleic acid, C18 linolelaidic acid, C18 α-linolenic acid, C18 γ-linolenic acid, C20 11-eicosenoic acid, C20 eicosapentaenoic acid, C20 dihomo-γ-linolenic acid, C20 arachidonic acid, C22 erucic acid, C22 clupanodonic acid, C22 docosahexaenoic acid, C24 nervonic acid and a mixture thereof.

Polymerized fatty acids are commercially available, and in particular the product having the trade name Pripol® sold by Croda can be used, and also the product having the trade name Empol@ sold by Cognis or the product having the trade name Unydime@ sold by Kraton or the product having the trade name Radiacid® sold by Oleon.

The fatty acid dimers can subsequently be converted into amine dimers, by transformation of the two acid functions into amine functions, or into amino acid dimers, by transformation of one of the acid functions into an amine function.

Preferably, the diacids used for the unit Y are acid dimers, and more particularly the C36 and C44 dimers are used.

Preferably, the unit Y is chosen from PA 236, PA 536, PA 636, PA 1036, PA pip36, PA pip44, PA 244, PA 544, PA 644, PA 1044, PA POP36, PA POP44, PA POP6, PA POP9, PA POP10, PA POP12 or PA POP14, POP being a polyetheramine with a molar mass of between 60 and 2000 g/mol.

The unit Y of the copolyamide according to the invention preferably has a Tg of less than 30° C., advantageously of less than 0° C. The glass transition temperature noted can be determined by differential scanning calorimetry (DSC) according to the standard ISO 11357-2:2013, Plastics-Differential Scanning calorimetry (DSC) Part 2. The heating and cooling rates are 20° C./min.

The copolyamide according to the invention comprises from 30 mol % to 99.5 mol % of unit X and from 0.5 mol % to 70 mol % of unit Y, preferably from 40 mol % to 98 mol % of unit X and from 2 mol % to 60 mol % of unit Y, and more particularly from 50 mol % to 90 mol % of unit X and from 10 mol % to 50 mol % of unit Y.

The molar percentages of the units X and Y are measured by calculating the percentage of the number of moles of monomers constituting the unit X, for example, relative to the sum of the number of moles of all of the monomers constituting the copolyamide, that is to say X and Y, this being done while excluding the chain limiter:

the diamine or the diacid in excess is not counted. The following formula illustrates the calculation:

$$\% mol = \frac{n ( monomers of unit X ) * 100}{\sum n ( monomers of copolyamide )} \qquad [ Form 1 ]$$

The copolyamide according to the invention has a melt viscosity, measured according to the standard ASTM D3236-88 (2009), of between 0.5 and 300 Pa·s at 200° C., preferably from 0.5 to 200 Pa·s, more preferably still from 1 to 100 Pa·s at 200° C., and more particularly from 2 to 30 Pa·s at 200° C. More particularly, the melt viscosity is measured with the aid of a Brookfield rheometer using the SC 4-27 module according to the standard ASTM D3236-88 (2009) at 200° C.

The copolyamide according to the invention preferably has a Tg of less than 20° C., advantageously of less than 0° C. The glass transition temperature noted can be determined by differential scanning calorimetry (DSC) according to the standard ISO 11357-2:2013, Plastics-Differential Scanning calorimetry (DSC) Part 2. The heating and cooling rates are 20° C./min.

Preferably, the copolyamide according to the invention comprises at least one of the units chosen from PA 26, PA 29, PA 210, PA 212, PA 214, PA 218, PA 56, PA 59, PA 510, PA 512, PA 66, PA 69, PA 610, PA 612, PA 6, PA 11, PA 12, PA 1010, PA 1012, PA 1212, PA pip10, PA pip36, PA pip44, PA POP40036, PA POP40044, PA POP40010, PA POP4006, PA POP200036, PA POP200044, PA POP200010, PA POP20006, PA3636, PA3644, PA 4436, PA 4444 and a mixture thereof.

Preferably, the copolyamide according to the invention is chosen from the following structures: PA 26/pip36, PA 210/pip36, PA 212/pip36, PA 214/pip36, PA 218/pip36, PA 59/pip36, PA 510/pip36, PA 512/pip36, PA 610/pip36, PA 612/pip36, PA 6/pip36, PA 1010/pip36, PA 1012/pip36, PA 1212/pip36, PA 26/pip44, PA 210/pip44, PA 212/pip44, PA 214/pip44, PA 218/pip44, PA 59/pip44, PA 510/pip44, PA 512/pip44, PA 610/pip44, PA 612/pip44, PA 6/pip44, PA 1010/pip44, PA 1012/pip44, PA 1212/pip44, PA 26/POP40036, PA 210/POP40036, PA 212/POP40036, PA 214/POP40036, PA 218/POP40036, PA 59/POP40036, PA 510/POP40036, PA 512/POP40036, PA 610/POP40036, PA 612/POP40036, PA 6/POP40036, PA 1010/POP40036, PA 1012/POP40036, PA 1212/POP40036, PA 26/POP40010, PA 210/POP40010, PA 212/POP40010, PA 214/POP40010, PA 218/POP40010, PA 59/POP40010, PA 510/POP40010, PA 512/POP40010, PA 610/POP40010, PA 612/POP40010, PA 6/POP40010, PA 1010/POP40010, PA 1012/POP40010, PA 1212/POP40010, PA 26/POP4006, PA 210/POP4006, PA 212/POP4006, PA 214/POP4006, PA 218/POP4006, PA 59/POP4006, PA 510/POP4006, PA 512/POP4006, PA 610/POP4006, PA 612/POP4006, PA 6/POP4006, PA 1010/POP4006, PA 1012/POP4006, PA 1212/POP4006, PA 26/3636, PA 210/3636, PA 212/3636, PA 214/3636, PA 218/3636, PA 59/3636, PA 510/3636, PA 512/3636, PA 610/3636, PA 612/3636, PA 6/3636, PA 1010/3636, PA 1012/3636, PA 1212/3636, PA 26/3636, PA 210/3636, PA 212/3636, PA 214/3636, PA 218/3636, PA 59/3636, PA 510/3636, PA 512/3636, PA 610/3636, PA 612/3636, PA 6/3636, PA 1010/3636, PA 1012/3636, PA 1212/3636, PA 26/POP200036, PA 210/POP200036, PA 212/POP200036, PA 214/POP200036, PA 218/POP200036, PA 59/POP200036, PA 510/POP200036, PA 512/POP200036, PA 610/POP200036, PA 612/POP200036, PA 6/POP200036, PA 1010/POP200036, PA 1012/POP200036, PA 1212/POP200036, PA 26/pip36/POP40036, PA 210/pip36/POP40036, PA 212/pip36/POP40036, PA 214/pip36/POP40036, PA 218/pip36/POP40036, PA 59/pip36/POP40036, PA 510/pip36/POP40036, PA 512/pip36/POP40036, PA 610/pip36/POP40036, PA 612/pip36/POP40036, PA 6/pip36/POP40036, PA 1010/pip36/POP40036, PA 1012/pip36/POP40036, PA 1212/pip36/POP40036, PA 26/pip36/POP200036, PA 210/pip36/POP200036, PA 212/pip36/POP200036, PA 214/pip36/POP200036, PA 218/pip36/POP200036, PA 59/pip36/POP200036, PA 510/pip36/POP200036, PA 512/pip36/POP200036, PA 610/pip36/POP200036, PA 612/pip36/POP200036, PA 6/pip36/POP200036, PA 1010/pip36/POP200036, PA 1012/pip36/POP200036, PA 1212/pip36/POP200036, PA 26/pip36/POP4006, PA 210/pip36/POP4006, PA 212/pip36/POP4006, PA 214/pip36/POP4006, PA 218/pip36/POP4006, PA 59/pip36/POP4006, PA 510/pip36/POP4006, PA 512/pip36/POP4006, PA 610/pip36/POP4006, PA 612/pip36/POP4006, PA 6/pip36/POP4006, PA 1010/pip36/POP4006, PA 1012/pip36/POP4006, PA 1212/pip36/POP4006, PA 26/pip36/POP20006, PA 210/pip36/POP20006, PA 212/pip36/POP20006, PA 214/pip36/POP20006, PA 218/pip36/POP20006, PA 59/pip36/POP20006, PA 510/pip36/POP20006, PA 512/pip36/POP20006, PA 610/pip36/POP20006, PA 612/pip36/POP20006, PA 6/pip36/POP20006, PA1010/pip36/POP20006, PA 1012/pip36/POP20006, PA 1212/pip36/POP20006; POP20006 means that this is a unit resulting from the condensation of a polyetheramine of polyoxypropylene formula having a molar mass of 2000 g with a C6 diacid.

Particularly preferably, the copolyamide according to the invention comprises a unit X chosen from a diamine.diacid unit and a unit Y comprising piperazine as Cd diamine and a diacid comprising more than 6 carbon atoms as Ce diacid.

According to another preferred embodiment, the Ce diacid is a C36 or C44 acid dimer.

According to yet another embodiment, the copolyamide according to the invention comprises a unit X of (Ca diamine). (Cb diacid) type comprising an average number of carbon atoms per nitrogen atom of greater than or equal to 6 and a unit Y comprising piperazine as Cd diamine and a diacid comprising more than 6 carbon atoms as Ce diacid.

Preferably, the copolyamide according to the invention comprises, as Ce diacid, an acid dimer or else a polyetheramine as Cd diamine.

According to a preferred embodiment, the copolyamide according to the invention is chosen from PA 26/pip36, PA 210/pip36, PA 59/pip36, PA 510/pip36, PA 512/pip36, PA 610/pip36, PA 210/POP40036, PA 59/POP40036, PA 510/POP40036, PA 610/POP40036, PA 210/POP40010, PA 59/POP4009, PA 510/POP40010, PA 26/POP4006, PA 210/POP4006, PA 610/POP4006, PA 26/pip36/POP40036, PA 210/pip36/POP40036, PA 510/pip36/POP40036, PA 610/pip36/POP40036, PA 6/pip36/POP40036, PA 210/pip36/POP200036, PA 59/pip36/POP200036, PA 510/pip36/POP200036, PA 512/pip36/POP200036, PA 610/pip36/POP200036, PA 210/pip36/POP20006, PA 610/pip36/POP20006.

According to one embodiment of the invention, the copolyamide consists of the two units X and Y defined above.

According to another embodiment, which is preferred, the copolyamide comprises more than two units X and Y defined above. Preferably, the copolyamide included in the composition according to the invention comprises at least three different units. For example, the copolyamide according to the invention can comprise two units X and one unit Y, one unit X and two units Y or also two units X and two units Y. Preferably, the copolyamide included in the composition according to the invention is a terpolyamide and a tetrapolyamide.

Preferably, the copolyamide according to the invention comprises fatty acid dimer, advantageously in a content of 1 mol % to 35 mol %, preferably of 2 mol % to 30 mol %, preferentially of 7 mol % to 25 mol %, relative to the total number of moles of the copolyamide.

Preferably, the copolyamide according to the invention comprises a content of polyetherdiamine of between 0.5 mol % and 25 mol %, preferably between 1 mol % and 22 mol %, preferentially between 1.5 mol % and 14 mol %, relative to the total number of moles of the copolyamide.

The piperazine content in the copolyamide is preferably less than 40 mol %, advantageously less than 30 mol %, very advantageously less than 20 mol %, relative to the total number of moles of the copolyamide.

### Chain Limiter

The copolyamides of the invention are synthesized conventionally, in the presence, if need be, of chain limiters or chain terminators.

The chain terminators suitable for reacting with the terminal amine function can be monocarboxylic acids, as anhydrides, such phthalic anhydride, monohalogenated acids, monoesters or monoisocyanates.

Preferably, monocarboxylic acids are used. They can be chosen from aliphatic monocarboxylic acids, such as acetic acid, propionic acid, lactic acid, valeric acid, caproic acid, capric acid, lauric acid, tridecylic acid, myristic acid, palmitic acid, stearic acid, pivalic acid and isobutyric acid; alicyclic acids, such as cyclohexanecarboxylic acid; aromatic monocarboxylic acids, such as benzoic acid, toluic acid, α-naphthalenecarboxylic acid, β-naphthalenecarboxylic acid, methylnaphthalenecarboxylic acid and phenylacetic acid; and mixtures thereof. Preferred compounds are aliphatic acids, and in particular acetic acid, propionic acid, lactic acid, valeric acid, caproic acid, capric acid, lauric acid, tridecylic acid, myristic acid, palmitic acid and stearic acid.

Mention may be made, among the chain terminators suitable for reacting with the terminal acid function, of monoamines, monoalcohols and monoisocyanates.

Preferably, monoamines are used. They can be chosen from aliphatic monoamines, such as methylamine, ethylamine, propylamine, butylamine, hexylamine, octylamine, decylamine, laurylamine, stearylamine, dimethylamine, diethylamine, dipropylamine and dibutylamine; alicyclic amines, such as cyclohexylamine and dicyclohexylamine; aromatic monoamines, such as aniline, toluidine, diphenylamine and naphthylamine; and mixtures thereof.

The preferred compounds are butylamine, hexylamine, octylamine, decylamine, laurylamine, stearylamine, cyclohexylamine and aniline.

The chain limiters can also be a dicarboxylic acid, which is introduced in excess relative to the stoichiometry of the diamine(s); or also a diamine, which is introduced in excess relative to the stoichiometry of the diacid(s).

According to a preferred embodiment, the copolyamide present in the composition according to the invention is wholly or partly a recycled copolyamide. When the polyamide is a recycled polyamide, it contains functions resulting from oxidation reactions chosen from imide, alcohol or carboxylic acid functions, preferably imide or alcohol functions, in a molar ratio, relative to the amide functions, greater than that of the same nonrecycled polyamide.

According to one embodiment, said molar ratio of the functions resulting from oxidation reactions, that is to say the sum of the number of moles of the imide, acid and alcohol functions to the number of moles of amide functions of the copolyamide, is between 1/10 000 and 1/20.

This ratio can be measured by calculating the concentrations by proton NMR. The copolyamide sample is prepared by dissolving the copolyamide in dichloromethane-d2, while adding HFIP (hexafluoroisopropanol).

In a first alternative form, said molar ratio of the imide functions is between 1/1000 and 1/20, in particular between 1/500 and 1/20, especially between 1/200 and 1/50.

In a second alternative form, said molar ratio of the carboxylic acid functions is between 1/5000 and 1/20, in particular between 1/3000 and 1/50, very advantageously between 1/500 and 1/25.

In a third alternative form, said molar ratio of the alcohol functions is between 1/1000 and 1/20 and advantageously between 1/1000 and 1/25, very advantageously between 1/200 and 1/50.

Preferably, the copolyamide present in the composition preferably has a melting temperature of between 10° and 220° C., advantageously between 12° and 200° C., very advantageously between 13° and 180° C.

The water content of the copolyamide after exposure to 23° C. and 50% relative humidity (measurement carried out at equilibrium) is preferably between 0.1% and 1.2% by weight, advantageously from 0.15% to 0.7% by weight, relative to the total weight of the copolyamide.

The copolyamide described above constitutes the matrix of the composition according to the invention.

### The Carbon-Based Filler

The composition according to the invention comprises at least one filler, the content of carbon atoms of which is between 60% and 100% relative to the number of atoms constituting the filler. Preferably, the filler comprises from 80% to 100% carbon atoms, more particularly from 94% to 99.99%, relative to the number of atoms constituting the filler.

The filler can be chosen from natural graphites, synthetic graphites, expanded graphites, graphenes, carbon blacks and carbon fibers. Preferably, the filler is chosen from natural graphites, synthetic graphites and expanded graphites.

The graphite used in the composition according to the invention can be produced synthetically or naturally. There exist three types of naturally produced graphite which are available commercially. These are flake graphite, amorphous graphite and crystalline graphite.

Flake graphite, as its name suggests, exhibits a flake morphology. Amorphous graphite is not really amorphous, as its name suggests, but is in fact crystalline. Amorphous graphite is available in average sizes from approximately 5 micrometers to approximately 10 centimeters. Crystalline graphite generally exhibits a vein appearance on its external surface, hence its name. Crystalline graphite is commercially available in the form of flakes from Asbury Graphite and Carbon Inc Carbons.

Synthetic graphite can be produced from coke and/or pitch which are derived from petroleum or coal. Synthetic graphite is of greater purity than natural graphite but is not as crystalline. One type of synthetic graphite is electrographite, which is produced from calcined petroleum coke and from coal tar pitch in an electric furnace. Another type of synthetic graphite is produced by heating calcined petroleum pitch at 2800° C. Synthetic graphite tends to have a lower density, a higher porosity and a higher electrical resistance than natural graphite.

Preferably, the “carbon-based” filler has a D50 median average particle size ranging from 0.5 to 500 micrometers. Within this range, the filler particles having D50 sizes of from 1 to 200 μm, preferably from 20 to 150 μm, can advantageously be used.

Preferably, the carbon-based filler has a D90 average particle size ranging from 1 to 400 micrometers, advantageously from 2 to 200 μm, very advantageously from 5 to 150 μm.

The D50 and D90 values can be estimated according to the standard ISO 13320-1:1999.

In one embodiment, the carbon-based filler, and consequently the composition, does not comprise particles with a diameter of greater than 500 μm, and advantageously does not comprise particles with a diameter of greater than 400 μm.

When the carbon-based filler is not 100% composed of carbon, the impurities are preferably chosen from the following chemical species: SiO2, Fe2O3, Al2O3, CaO, MgO, K2O, Na2O, TiO2, MnO and P2O5.

According to one embodiment, the BET specific surface area of the carbon-based filler measured according to ISO 9277:2010 is between 1 and 300 m²/g, very advantageously between 1.5 and 200 m²/g.

Preferably, these fillers have a mean form factor of greater than 3, advantageously of greater than 7, very advantageously of greater than 15.

Scanning electron microscopy makes possible observation and visual assessment of the morphology of the compounds. Morphometry, based on video acquisition and on image analysis, makes it possible to access quantifiable parameters characteristic of the morphology of the particles. Various commercial devices exist: mention may be made, by way of example, of the Morphologi G2 appliance from Malvern, the Camsizer appliance from Retsch and the Alpaga 500 Nano appliance from Occhio, described on the Internet pages www.malvern.com, www.retsch-technology.com or also www.occhio.be.

By means of the Alpaga 500 Nano apparatus, for each sample tested, acquisitions are carried out on 10 000 particles and the elongation and roundness parameters are calculated for each particle.

The mathematical tools used for their calculation are developed in the doctoral thesis of E. Pirard (1993, University of Liège, 253 pages) entitled “Morphométrie euclidienne des figures planes. Applications à l′analyse des matériaux granulaires [Euclidean morphometry of flat figures. Applications in the analysis of granular materials]”. The document entitled “The descriptive and quantitative representation of particle shape and morphology” is available under the reference ISO/DIS 9276-6.

Preferably, the carbon-based filler has a density of less than 3 kg/L, advantageously of less than 2.5 kg/L, very advantageously of less than 2.3 kg/L. The density is measured in accordance with the standard ISO 787-10:1993.

Preferably, when the carbon-based filler is expanded graphite, then it is present in the composition according to the invention in a content of between 5% and 17% by weight relative to the total weight of the composition. When the carbon-based filler is not expanded graphite, then it is present in the composition according to the invention in a content of between 5% and 35% by weight relative to the total weight of the composition. More preferentially, when the carbon-based filler is not expanded graphite, then it is present in the composition of the invention in a content of between 10% and 29.90% by weight, and more preferentially still between 10% and 25% by weight, relative to the total weight of the composition.

### The Electrically Insulating Filler

The composition according to the invention comprises at least one electrically insulating filler chosen from oxides of metals and nitrides.

With preference, the electrically insulating filler is chosen from boron nitrides, aluminum nitrides, aluminum oxide, magnesium oxide, zinc oxide, aluminosilicate, zirconium oxide or mixtures of these. Preferably, the electrically insulating filler is chosen from metal oxides, and more particularly from aluminum oxide, zinc oxide and aluminosilicate.

Advantageously, the composition according to the invention comprises from 17% to 60% by weight, very advantageously from 25% to 55% by weight, very advantageously from 25% to 50%, more advantageously still from 30% to 50% by weight, of electrically insulating filler relative to the weight of the composition according to the invention. More advantageously still, the composition according to the invention comprises from 40% to 50% by weight of electrically insulating filler relative to the weight of the composition according to the invention.

In the composition according to the invention, the sum of the contents of carbon-based filler and of electrically insulating filler is between 30% and 75% by weight relative to the total weight of the composition, preferably between 40% and 65%.

Said fillers have a D90 median average particle size ranging from 1 to 400 micrometers.

In one embodiment, the BET specific surface area of the electrically insulating filler measured according to ISO 9277:2010 is between 0.1 and 80 m²/g, advantageously between 0.5 and 50 m²/g, and very advantageously between 0.6 and 30 m²/g.

It is desirable to use fillers having D50 median average particle sizes of approximately 0.5 to approximately 200 micrometers. Within this range, the electrically insulating fillers having D50s of from 1 to 100 μm, preferably from 1.5 to 50 μm, can advantageously be used.

It is also desirable to use fillers comprising few very large particles. It is therefore desirable for the D90 of the filler to be from 1 to 100 μm, advantageously from 2 to 70 μm.

In a preferred embodiment, the fillers are coated with a size in order to improve compatibility with the polyamide. This size is advantageously reactive with the polyamide of the invention. The size may, for example, be chosen from aminosilanes, epoxysilanes or polyurethanes.

### The Additives

The composition according to the invention can comprise at least one additive.

The additive can be chosen from a catalyst, an antioxidant, a heat stabilizer, a UV stabilizer, a light stabilizer, a lubricant, a flame retardant, a nucleating agent, a chain extender and a dye.

Advantageously, the composition defined above furthermore comprises additives chosen from antioxidants, UV stabilizers, heat stabilizers, plasticizers, nucleating agents, tackifying agents, impact modifiers, flame retardants, antistatic agents, reinforcing agents, lubricants, organic and inorganic fillers, optical brighteners, mold-release agents, pigments, dyes, catalysts and mixtures thereof.

The composition can comprise between 0% and 10% by weight of additives, relative to the total weight of the composition, preferably between 0.1% and 5% of additive.

According to a particular embodiment of the invention, the composition consists of the copolyamide as defined above as matrix, at least one carbon-based filler, the content of carbon atoms of which is between 60% and 100%, and at least one electrically insulating filler chosen from oxides of metals and nitrides; the sum of the contents of carbon-based filler and of electrically insulating filler is between 30% and 75% by weight relative to the total weight of the composition; and said fillers have a D90 median average particle size ranging from 1 to 400 micrometers.

Preferably, the composition has a melting point of less than 220° C., advantageously of less than 200° C., very advantageously of less than 180° C. This low melting point is preferable so as not to damage the parts to be overmolded.

The composition advantageously has an elongation at break (during ISO 527 tensile tests at 23° C.) of greater than 10%, advantageously of greater than 30%. The tensile modulus at 23° C. thereof, measured on a 1A test specimen (ISO 527), is preferably between 100 and 5000 MPa, advantageously between 200 and 4000 MPa, very advantageously between 200 and 800 MPa.

Preferably, the composition has a dielectric constant (Dk), measured at 1 GHZ, of between 2 and 6, advantageously from 2.5 to 4, and the dissipation factor (tan 0) is between 0.001 and 0.1, advantageously between 0.005 and 0.05. The dielectric constant and the dissipation factor are measured according to the standard ASTM D150 on a 100*100*2 mm plate at a frequency of 1 GHz. This low dielectric constant makes it possible to avoid any interference with the encapsulated electronic or electrical devices.

The melt viscosity of the composition is advantageously between 0.5 and 400 Pa·s, very advantageously between 2 and 200 Pa·s, preferably between 3 and 100 Pa·s. The melt viscosity is measured with the aid of a Brookfield rheometer using the SC 4-27 module according to the standard ASTM D3236-88 (2009) at 210° C.

The composition according to the invention preferably has a surface resistivity of greater than 1010 Ω.m, preferably of greater than 1011 Ω.m, measured according to the standard IEC 62631 Mar. 2 (2015). In other words, the composition is electrically insulating.

The composition according to the invention preferably has a thermal conductivity of between 0.9 W/m.K and 4 W/m.K, advantageously from 1 W/m.K to 3 W/m.K, measured according to the standard ASTM D5930-17.

The invention also relates to the encapsulation process using the composition according to the invention.

The composition according to the invention is used to manufacture molded parts by low-pressure injection molding. This injection-molding cycle can comprise the various following steps:
a) the mold is closed after the parts to be adhesively bonded have been inserted,
b) the molten composition according to the invention is injected into the mold up to a pressure of between 0.5 and 50 bar and optionally subjected to a holding pressure,
c) the molding composition is left to solidify by cooling,
d) the mold is opened,
e) the injection-molded parts are withdrawn from the mold.

The low-pressure injection molding process generally operates in the range from 2 to 40 bar, the temperature being between 16° and 250° C.

Thus, the composition according to the invention is capable of being injected at low pressure, that is to say at a pressure of less than 100 bar, preferably of less than 50 bar.

### Use

According to yet another aspect, the present invention relates to the use of the composition according to the invention as defined above for the encapsulation of electronic devices, also called overmolding or molding, which are preferably located under the engine hood of a vehicle or in medical appliances.

The present invention also relates to the use of the composition according to the invention as defined above for the manufacture of a hot-melt adhesive in the form of a web, a film, granules, a filament, a grid or a powder.

The invention is illustrated by the following figure and examples which are in no way limiting.

### EXAMPLES

### 1. Preparation of Compositions and Measurements

The compositions were obtained by melt mixing of the components described in tables 1 and 2 below.

All the above compositions were manufactured using an 18 mm ZSK twin-screw extruder (Coperion). The temperature of the barrels was set to 210° C. and the speed of the screws was 280 rpm with a flow rate of 8 kg/h. The compositions were subsequently dried under reduced pressure at 80° C. in order to achieve a moisture content of less than 0.04%.

1A test specimens (according to the standard ISO 527) and 5 mm plates were manufactured by injection molding with the aid of a Battenfeld BA800 CDC press using unpolished molds. The following parameters were applied during the injection:
Barrel temperature: 120° C.
Nozzle temperature: 150° C.
Mold temperature: 15° C.
Cycle time: 60 seconds.

TABLE 1

| | 1 | 2 | 3 | 4 |
|---|---|---|---|---|
| % by mass | Inv | Comp | Inv | Comp |
| Polyamide A¹ | 50 | 50 | 50 | — |
| Polyamide B² | — | — | — | 50 |
| Graphite 1³ | — | 15 | — | — |
| Graphite 2⁴ | 15 | — | 15 | 15 |
| Zinc oxide⁵ | — | — | 35 | 35 |
| Aluminosilicate⁶ | 35 | 35 | — | — |
| λ (W/m · K) | 1.101 | 1.17 | 1.169 | 1.11 |
| Surface | smooth | granular | smooth | smooth |
| appearance | | | | |
| Viscosity and | yes | yes | yes | no |
| melting temperature | | | | |
| suitable for low- | | | | |
| pressure | | | | |
| overmolding | | | | |
| Elongation at break (%) | 51 | 13 | 56 | ND |

In table 1 above:
¹Polyamide A denotes a hot-melt adhesive polyamide composed of 31 mol % of C10 diacid, 19% of Pripol 1013, 25 mol % of piperazine, 6.6 mol % of Jeffamine ® D2000 and 18.4 mol % of ethylenediamine. Polyamide A has a melting point of less than 180° C. and a melt viscosity measured according to the standard ASTM D3236-88 (2009) of 22 Pa · s at 200° C.
The Tg of the polyamide is −22° C. measured in DSC.
The formula of polyamide A is 210/pip10/pip36/POP36, pip being piperazine and POP being Jeffamine@ D2000. The nomenclature used to define polyamides is described in the standard ISO 1874-1: 1992, “Plastics - Polyamide (PA) moulding and extrusion materials - Part 1: Designation”, in particular on page 3 (tables 1 and 2).
⁶Polyamide B denotes a PA 6 having a melting point of 220° C. and a melt viscosity measured according to the standard ASTM D3236-88 (2009) of 325 Pa · s at 280° C.
³Graphite 1 denotes the graphite having the trade name Timrex ® KS 15-600SP sold by Imerys. This grade is characterized by a D90 of greater than 500 μm according to the TDS.
⁴Graphite 2 denotes the graphite having the trade name Timrex ® M100 sold by Imerys. This grade is characterized by a D90 of less than 400 μm.
⁵Zinc oxide denotes the product having the trade name Silatherm ® 1438-800 AST sold by Quarzwerk GmbH.
⁶Aluminosilicate denotes the product having the trade name Silatherm ® 1466-100 AST sold by Quarzwerk GmbH.
⁵Expanded graphite denotes the graphite having the trade name Timrex ® C Therm HD max sold by Imerys.

TABLE 2

| | 5 | 6 | 7 | 8 |
|---|---|---|---|---|
| % by mass | Inv | Inv | Inv | Inv |
| Polyamide A | 50 | 62 | 52 | 57 |
| Graphite 2 | 25 | — | — | — |
| Expanded | — | 8 | 8 | 8 |
| graphite | | | | |
| Zinc oxide | — | 30 | 40 | 15 |
| Aluminosilicate | 25 | — | — | 20 |
| λ (W/m · K) | 1.466 | 0.936 | 1.335 | 1.018 |
| Surface | smooth | smooth | smooth | smooth |
| appearance | | | | |
| Viscosity and | yes | yes | yes | yes |
| melting | | | | |
| temperature | | | | |
| suitable for low- | | | | |
| pressure | | | | |
| overmolding | | | | |
| Elongation at | 37 | 93 | 60 | 64 |
| break (%) | | | | |

In table 2 above:
¹ Polyamide A denotes a hot-melt adhesive polyamide composed of 31 mol % of C10 diacid, 19% of Pripol 1013, 25 mol % of piperazine, 6.6 mol % of Jeffamine ® D2000 and 18.4 mol % of ethylenediamine. Polyamide A has a melting point of less than 180° C. and a melt viscosity measured according to the standard ASTM D3236-88 (2009) of 22 Pa · s at 200° C.
The Tg of the polyamide is −22° C. measured in DSC.
The formula of polyamide A is 210/pip10/pip36/POP36, pip being piperazine and POP being Jeffamine ® D2000. The nomenclature used to define polyamides is described in the standard ISO 1874-1: 1992, “Plastics - Polyamide (PA) moulding and extrusion materials - Part 1: Designation”, in particular on page 3 (tables 1 and 2).
² Graphite 2 denotes the graphite having the trade name Timrex ® M100 sold by Imerys. This grade is characterized by a D90 of less than 400 μm.
³ Expanded graphite denotes the graphite having the trade name Timrex ® C Therm HD max sold by Imerys.
⁴ Zinc oxide denotes the product having the trade name Silatherm ® 1438-800 AST sold by Quarzwerk GmbH.
⁵ Aluminosilicate denotes the product having the trade name Silatherm ® 1466-100 AST sold by Quarzwerk GmbH.

In these examples, various physicochemical properties were tested. The thermal conductivity and the elongation at break were measured on the plates and on the test specimens (dumbbells) manufactured, according to the following methods.

### Thermal Conductivity

The thermal conductivity was measured at 23° C. on 100*100*5 mm plates with the aid of a Neotim FP2C machine equipped with a hot wire in accordance with the standard ASTM D5930-17.

### Elongation at Break:

The tensile tests were carried out on 1 BA dumbbells (Annex A of the standard ISO 527-2:2012) in accordance with the standard ISO 527-2:2012 at 23° C.

The surface appearance of the plates was also evaluated.

### Surface Appearance:

The surface appearance is evaluated by touch and visually. The characteristic: smooth is given to a sample the surface of which is smooth and soft to the touch and visually flat. The characteristic: granular is given to a sample the surface of which is granular and rough to the touch and visually bumpy.

The capacity of the composition to be used at low pressure was also evaluated. In order to be used at low pressure without damaging the parts to be injection molded, the compositions must combine a melting temperature of less than 220° C. and a melt viscosity measured according to the standard ASTM D3236-88 (2009) of between 0.5 and 300 Pa·s at 200° C.

### 2. Conclusion

Compositions 1, 3 and 5 to 8 have all the expected properties, in contrast to composition 2, which is poor in terms of elongation at break, and composition 4, which cannot be used in an overmolding process because of its viscosity and its excessively high melting point.

1-16. (canceled)

17. A hot-melt adhesive composition comprising:
i) at least one semicrystalline aliphatic copolyamide comprising at least two units corresponding to the following formula (1):
X/Y (1)
in which:
the unit X is a semicrystalline unit obtained by the polycondensation of a unit chosen from a C6 to C18 α,ω-aminocarboxylic acid, a C6 to C18 lactam and a (Ca diamine). (Cb diacid) unit, with a representing the number of carbon atoms of the diamine and b representing the carbon number of the diacid, a being between 2 and 18 and b being between 4 and 18, the Ca diamine and the Cb diacid being saturated or unsaturated, linear or branched aliphatic or cycloaliphatic,
the unit Y is a unit obtained by the polycondensation of a (Cd diamine). (Ce diacid) unit, with d representing the number of carbon atoms of the diamine and e representing the carbon number of the diacid, d and e being between 2 and 48, the Cd diamine and the Ce diacid being saturated or unsaturated, linear or branched aliphatic or cycloaliphatic, it being possible for the Cd diamine to be a polyetheramine,
the unit Y having a Tg of less than 30° C.,
the copolyamide having a melt viscosity, measured according to the standard ASTM D3236-88 (2009), of between 0.5 and 300 Pa·s at 200° C.,
the copolyamide constituting the matrix of the composition,
ii) at least one filler, the content of carbon atoms of which is between 60% and 100% relative to the number of atoms constituting the filler, and
iii) at least one electrically insulating filler chosen from oxides of metals and nitrides,
the sum of the contents of carbon-based filler and of electrically insulating filler is between 30% and 75% by weight relative to the total weight of the composition, said fillers having a D90 median average particle size ranging from 1 to 400 micrometers.

18. The composition as claimed in claim 17, characterized in that the carbon-based filler has a D50 median average particle size ranging from 0.5 to 500 micrometers.

19. The composition as claimed in claim 17, characterized in that the carbon-based filler has a BET specific surface area measured according to ISO 9277:2010 of between 1 and 300 m²/g.

20. The composition as claimed in claim 17, characterized in that the electrically insulating filler has a BET specific surface area measured according to ISO 9277:2010 of between 0.1 and 80 m²/g.

21. The composition as claimed in claim 17, characterized in that it has a melt viscosity of between 0.5 and 400 Pa·s.

22. The composition as claimed in claim 17, characterized in that it has a surface resistivity measured according to the standard IEC 62631 Mar. 2 (2015) of greater than 1010 Ω.m.

23. The composition as claimed in claim 17, characterized in that it has a melting point of less than 220° C.

24. The composition as claimed in claim 17, characterized in that the copolyamide comprises at least one of the units selected from the group consisting of PA 26, PA 29, PA 210, PA 212, PA 214, PA 218, PA 56, PA 59, PA 510, PA 512, PA 66, PA 69, PA 610, PA 612, PA 6, PA 11, PA 12, PA 1010, PA 1012, PA 1212, PA pip10, PA pip36, PA pip44, PA POP40036, PA POP40044, PA POP40010, PA POP4006, PA POP200036, PA POP200044, PA POP200010, PA POP20006, PA3636, PA3644, PA 4436, PA 4444 and a mixture thereof.

25. The composition as claimed in claim 17, characterized in that the copolyamide comprises a polyetheramine as Cd diamine or else an acid dimer as Ce diacid.

26. The composition as claimed in claim 17, characterized in that the copolyamide is a terpolyamide or a tetrapolyamide.

27. The composition as claimed in claim 17, characterized in that the composition comprises additives chosen from antioxidants, UV stabilizers, heat stabilizers, plasticizers, nucleating agents, tackifying agents, impact modifiers, flame retardants, antistatic agents, reinforcing agents, lubricants, organic and inorganic fillers, optical brighteners, mold-release agents, pigments, dyes, catalysts, and mixtures thereof.

28. The composition as claimed in claim 17, characterized in that it is capable of being injected at a pressure of less than 100 bar.

29. The composition as claimed in claim 17, characterized in that:
when the carbon-based filler is expanded graphite, then it is present in the composition in a content of between 5% and 17% by weight relative to the total weight of the composition;
when the carbon-based filler is not expanded graphite, then it is present in the composition in a content of between 5% and 35% by weight, relative to the total weight of the composition.

30. The composition as claimed in claim 17, characterized in that the electrically insulating filler is chosen from metal oxides.

31. The composition as claimed in claim 17, characterized in that it comprises from 17% to 60% by weight, of electrically insulating filler relative to the weight of the composition.

32. An electronic device assembly comprising an electronic device and the composition as defined in claim 17, wherein the electronic device is encapsulated in the composition.
